(19) United States
(12) Patent Application Publication
(10) Pub. No.: US 2018/0341682 A1
(43) Pub. Date: Nov. 29, 2018

(54) SYSTEM AND METHOD FOR GENERATING RULES FROM SEARCH QUERIES

(71) Applicant: Nutanix, Inc., San Jose, CA (US)

(72) Inventors: Himanshu Shukla, San Jose, CA (US); Atreyee Maiti, San Jose, CA (US); Rahul Singh, San Jose, CA (US)

(21) Appl. No.: 15/606,990

(22) Filed: May 26, 2017

(51) Int. Cl. G06F 17/30; G06N 5/02

(52) U.S. Cl. CPC G06F 17/30507; G06F 17/30985; G06F 17/30448; G06F 17/30864; G06F 17/30654; G06N 5/025

(57) ABSTRACT

A system and method for generating and executing rules in a virtual computing system includes creating, by a rules computing system of the virtual computing system, a rule based upon one or more search queries entered into a search interface of the virtual computing system. The system and method also include executing, by the rules computing system, the rule periodically for identifying violations of the rule, and issuing, by the rules computing system, an alert for the violations of the rule on the search interface.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently that utilize the hardware resources of the underlying one or more host machines. Each virtual machine may be configured to run an instance of an operating system. Modern virtual computing systems allow several operating systems and several applications to be safely run at the same time on the virtual machines of a single host machine, thereby increasing resource utilization and performance efficiency. However, present day virtual computing systems still have limitations due to their configuration and the way they operate.

### SUMMARY

In accordance with some aspects of the present disclosure, a method is disclosed. The method includes creating, by a rules computing system of a virtual computing system, a rule based upon one or more search queries entered into a search interface of the virtual computing system. The method further includes executing, by the rules computing system, the rule periodically for identifying violations of the created rule, and issuing, by the rules computing system, an alert for the violations of the rule on the search interface.

In accordance with some other aspects of the present disclosure, a system is disclosed. The system includes a rules computing system having a rules database configured to store one or more rules created by the rules computing system and a processing unit. The processing unit is configured to create the one or more rules based upon one or more search queries entered into a search interface, such that the rules computing system and the search interface are part of a virtual computing system. The processing unit is further configured to store the created ones of the one or more rules in the rules database, execute the created ones of the one or more rules periodically to detect violations of the created ones of the one or more rules, and generate alerts to be issued on the search interface based upon the detected violations.

In accordance with yet other aspects of the present disclosure, another method is disclosed. The method includes identifying, by a rules computing system, keywords in one or more search queries entered into a search interface for identifying a troubleshooting type search query, such that the rules computing system and the search interface are part of a virtual computing system. The method also includes proposing, by the rules computing system, one or more rules for each troubleshooting type search query, storing, by the rules computing system, at least one proposed rule in a rules database based upon a user input, and executing, by the rules computing system, the at least one proposed rule from the rules database periodically for identifying violations of the at least one proposed rule. The method further includes issuing, by the rules computing system, an alert for the violations, such that the alert is provided on the search interface.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 is a block diagram of a search computing system within the virtual computing system of FIG. 1, in accordance with some embodiments of the present disclosure.

FIG. 3 is a block diagram of a rules computing system that operates in collaboration with the search computing system of FIG. 2, in accordance with some embodiments of the present disclosure.

FIG. 4 is a block diagram of a rule creation system within the rules computing system of FIG. 3, in accordance with some embodiments of the present disclosure.

FIG. 5 is a block diagram of a rule validation system within the rules computing system of FIG. 3, in accordance with some embodiments of the present disclosure.

FIG. 6 is a flowchart outlining operations for creating rules using the rule creation system of FIG. 4, in accordance with some embodiments of the present disclosure.

FIG. 7 is a flowchart outlining operations for executing the created rules by the rule validation system of FIG. 5, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a rules computing system provided in a virtual computing system. The rules computing system is configured to automatically analyze search queries entered by a user in a search interface of the virtual computing system, and propose rules based upon the analysis. The rules computing system is also configured to create/store the proposed rules, as well as automatically detect violations of the created rules. In some embodiments, the rules computing system analyzes the search queries by identifying troubleshooting type search queries, and determining whether those search queries are frequently run by the user. Before proposing rules to be created for the search queries, the rules computing system may verify that those rules do not already exist in a rules database. If rules do not already exist, the rules computing system proposes one or more new rules to the user for each search query, and upon receiving confirmation from the user to create the proposed rule(s), the rules computing system stores the proposed rule(s) in the rules database.

In some embodiments, the rules computing system also periodically executes or runs the rules in the rules database to detect any violations of those rules. When violations are detected, the rules computing system may generate alerts and present those alerts to the user for review. In some embodiments, the rules computing system may be configured to gather additional information regarding the rule violations, such as, the cause(s) of the rule violations, and suggested ways to cure the rule violations. The rules computing system may provide any such additional information as part of the alerts to the user for review. Thus, the present disclosure provides an automated rule system that proposes, creates, and executes rules for commonly run search queries.

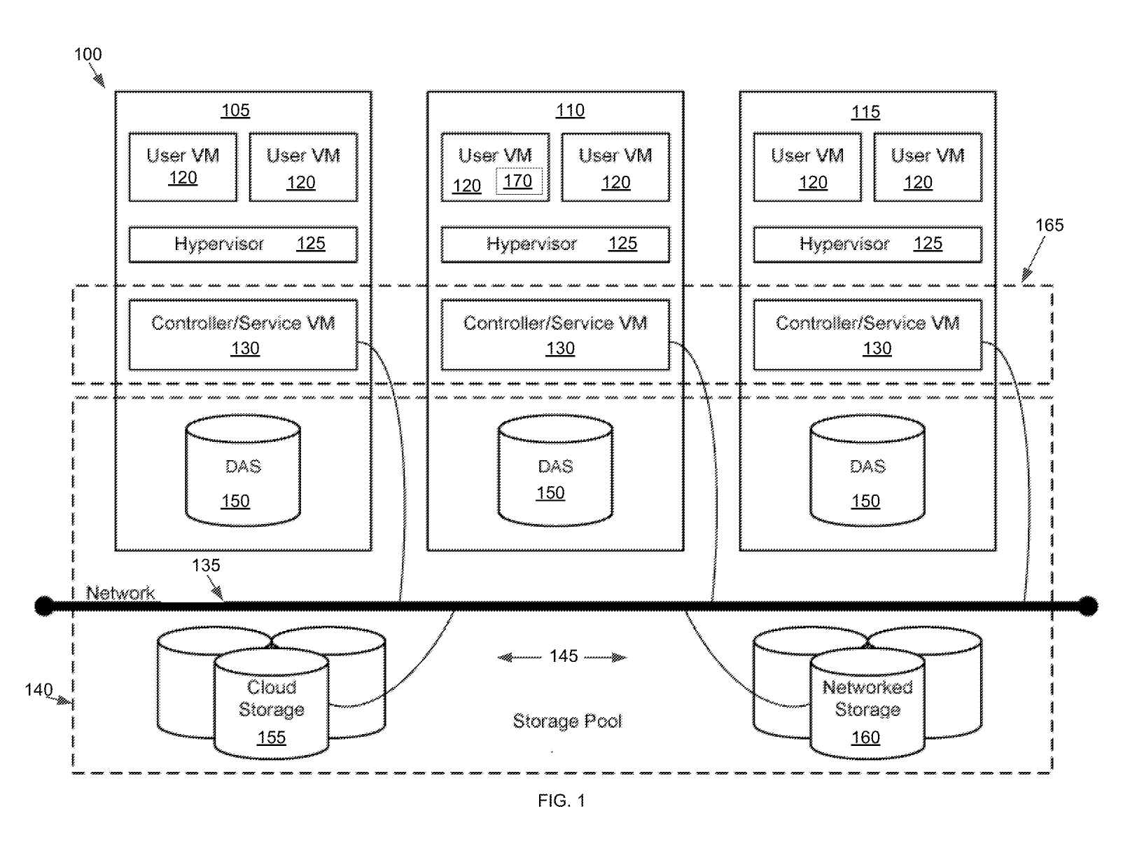

Referring now to FIG. 1, a virtual computing system 100 is shown, in accordance with some embodiments of the present disclosure. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on each of the first, second, and third nodes may vary to include either a single user VM or more than two user VMs. Further, each of the first node 105, the second node 110, and the third node 115 need not always have the same number of the user VMs 120. Additionally, more than a single instance of the hypervisor 125 and/or the controller/service VM 130 may be provided on each of the first node 105, the second node 110, and the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 135. For example, in some embodiments, each of the first node 105, the second node 110, and the third node 115 may communicate and share resources with each other via the controller/service VM 130 and/or the hypervisor 125. Additionally and generally speaking, each of the first node 105, the second node 110, and the third node 115 may have attributes that are typically needed or desired in nodes of a virtual computing system (e.g., the virtual computing system 100). Each of the first node 105, the second node 110, and the third node 115 may also be organized in a variety of network topologies, and may be termed as a “host” or “host machine.”

Also, although not shown, each of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may be deemed to be one cluster. Multiple clusters may exist within a given virtual computing system. The user VMs 120 that are part of a cluster may be configured to share resources with each other.

Further, as shown herein, one or more of the user VMs 120 may be configured to have a search computing system 170. In some embodiments, the search computing system 170 may be provided on one or more of the user VMs 120 of the leader node, while in other embodiments, the search computing system 170 may be provided on another node. Although the search computing system 170 has been shown as being provided on one of the user VMs 120, in some embodiments, the search computing system may be provided on multiple user VMs. In yet other embodiments, the search computing system 170 may be provided on a computing machine that is outside of the first node 105, the second node 110, and the third node 115, but connected to those nodes in operational association. In some such embodiments, the computing machine on which the search computing system 170 is provided may be either within the virtual computing system 100 or outside of the virtual computing system and operationally associated therewith. Generally speaking, the search computing system 170 may be connected to and receive data from one or more clusters within the virtual computing system 100. Thus, either a single instance of the search computing system 170 or multiple instances of the search computing system, with each search computing system instance being connected to one or more clusters may be provided.

Furthermore, the search computing system 170 may be used to receive search queries from a user and provide results back to the user in response to the received search queries. The search results may correspond to data received back from the cluster(s) that are connected to and communicating with the search computing system 170. Additional details of the search computing system are provided in U.S. application Ser. No. 15/143,060, filed on Apr. 29, 2016, the entirety of which is incorporated by reference herein.

In some embodiments and as described below, the search computing system 170 may be used for troubleshooting purposes as well. For example, the search computing system 170 may be used by a user to run troubleshooting type search queries to identify various undesirable conditions within the virtual computing system 100. In some embodiments and, as discussed below, the search queries from the search computing system 170 may be analyzed to create a variety of rules to facilitate automatic identification of those undesirable conditions. By creating such rules, the present disclosure avoids the need for the user to repeatedly run search queries to identify the undesirable conditions, thereby saving time, and effectively and efficiently facilitating the detection of those undesirable conditions. In some embodiments, the search queries may be analyzed to create rules for conditions that are not related to troubleshooting. For example, in some embodiments, the present disclosure may be used by personnel from accounting and billing to identify certain parameters (e.g., number of VMs used by a particular customer) other than troubleshooting to facilitate customer billing. Thus, a “user” may be an administrator managing the virtual computing system 100, or another entity.

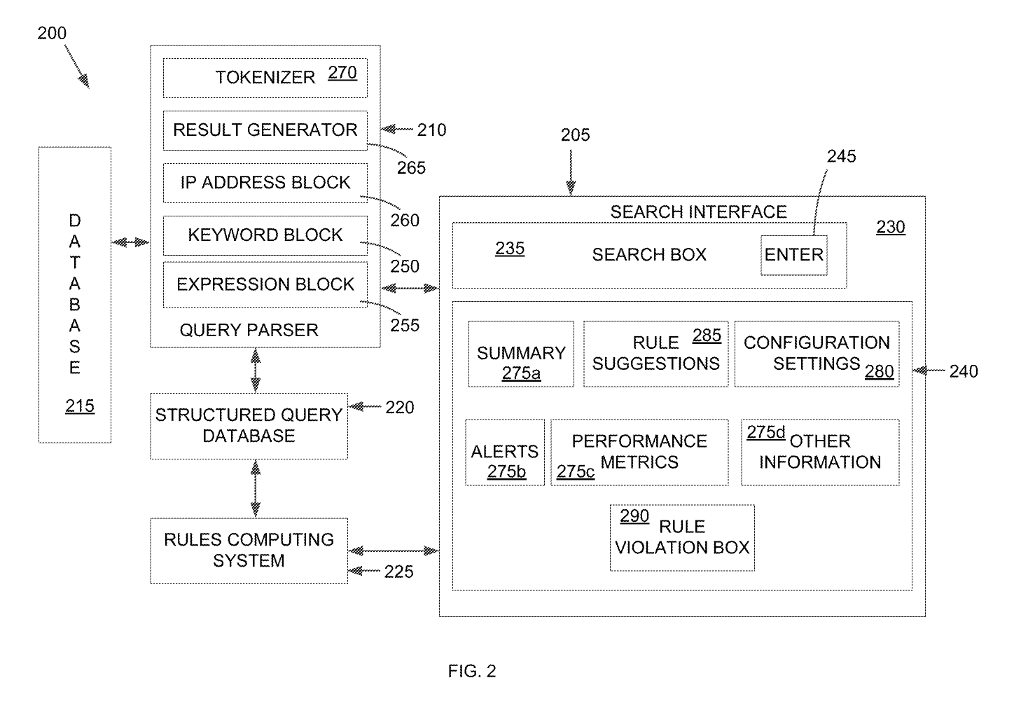

Turning to FIG. 2, a block diagram of an example search computing system 200 is shown, in accordance with some embodiments of the present disclosure. The search computing system 200 includes a search interface 205 that is configured to receive search queries from the user and provide search results back to the user. The search computing system 200 is a contextual search system that identifies the context of a search query and particularly, identifies the intent of the user in running the search query. The search computing system 200 may identify the intent of the user by analyzing the search query, as detailed below, to determine whether the user is in a troubleshooting mode, exploration mode, a management mode, or another type of work flow mode. The search computing system 200 may return results back based upon the identified intent of the user.

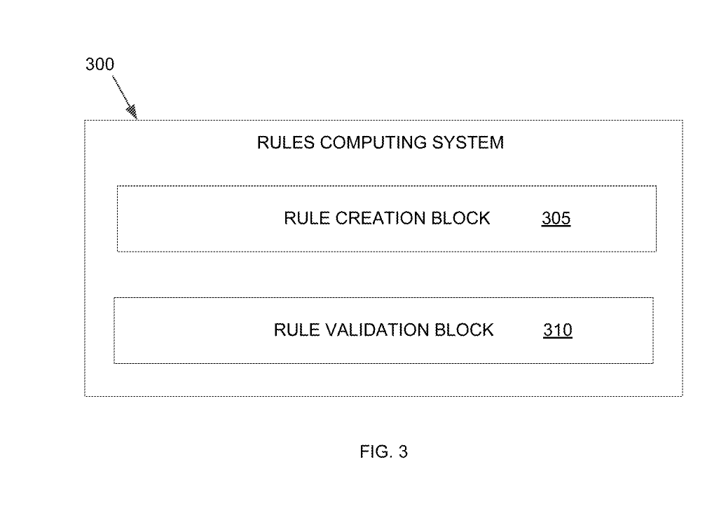

Specifically, upon receiving a search query, the search interface 205 communicates with a query parser 210. The query parser 210 parses the search query, converts the parsed search query into a structured query, retrieves, compiles, and returns the search results back to the search interface 205. To facilitate parsing of the search query, converting into a structured query, and for retrieving the search results, the query parser 210 communicates with database 215 and structured query database 220. Each of the search interface 205, the query parser 210, the database 215, and the structured query database 220 is described in greater detail below. The search computing system 200 also includes a rules computing system 225, which may be used to identify certain type of search queries for which rules may be created. The rules computing system 225 is described in greater detail below in FIGS. 3-7.

The search interface 205 includes a user interface 230 having a search box 235 for receiving search queries from the user and a search display box 240 for displaying the search results retrieved in response to the search queries entered into the search box. Thus, the user interface 230 is configured to receive information from and provide information to the user. The user interface 230 may be any suitable user interface. For example, the user interface 230 may be an interface for receiving user input and/or machine instructions for entry into the search box 235. The user interface 230 may use various input technologies including, but not limited to, a keyboard, a stylus and/or touch screen, a mouse, a track ball, a keypad, a microphone, voice recognition, motion recognition, disk drives, remote controllers, input ports, one or more buttons, dials, joysticks, etc. to allow an external source, such as the user, to enter information into the search box 235.

The user interface 230 may also be configured to provide an interface for presenting information from the search computing system 200 to external systems, users, memory, etc. For example, the user interface 230 may display the search results within the search display box 240. Alternatively or additionally, the user interface 230 may include an interface for a printer, speaker, alarm/indicator lights, etc. to provide or augment the search results. The user interface 230 can be provided on a color display, a cathode-ray tube (CRT), a liquid crystal display (LCD), a plasma display, an organic light-emitting diode (OLED) display, etc. Further, only certain features of the user interface 230 are shown herein. Nevertheless, in other embodiments, other features that are commonly provided on user interfaces and particularly, on user interfaces used in a virtualization environment (e.g., the virtual computing system 100) may be provided. For example, in some embodiments, the user interface 230 may include navigational menus, adjustment options, adjustment settings, adjustment display settings, etc. The user interface 230 may also be configured to communicate with the query parser 210 and any additional components within the virtual computing system 100 that are deemed desirable to communicate with the search interface 205.

Thus, the user inputs a search query into the search box 235 and interacts with (e.g., click, press-and-hold, roll or hover over, etc.) a search button 245 to send the search query for further processing and retrieval of search results. The search interface 205 and particularly, the search box 235, may be configured to receive and recognize a variety of configurations of the search query. For example, in some embodiments, the user may input the search query in the form of keywords. Keywords are pre-defined terms or phrases that are understood by the search computing system 200. A list of all keywords understood by the search computing system 200 may be stored within (e.g., the database 215) or accessible by the search computing system. The list of keywords may also be made available to the user.

Each keyword may be classified into one or more of four categories: entity type, properties, identifiers, and actions. “Entity type” keywords may include the different entities, such as, clusters, nodes, virtual machines, virtual disks, and other hardware, storage, applications, virtual clouds, and data center components that make up the virtual computing system 100. “Properties” keywords include various attributes, such as type of operating system, number of processing units, number of storage units, etc. of each “entity type.” “Properties” keywords may also include a value of a given attribute, such as the value of an IP address, values of various statistics and metrics, such as processing unit utilization, disk space, etc. for each “entity type.” The “identifiers” keywords may include any identification information that may be used to uniquely identify an “entity type.” For example, the “identifiers” keywords may include entity name (e.g., host name, cluster name, etc.), entity version, or any other identifying information that may be used to uniquely identify and distinguish one “entity type” from another “entity type” within a cluster. The “actions” keywords may include any actions that a particular “entity type” may be authorized to perform. For example, “actions” keywords may include create, modify, delete, add, etc. that an “entity type” may perform.

In addition to simple keywords, in some embodiments, the user may enter the search query in the form of an expression. Expressions may include phrases or keywords that are separated by an operator (e.g., =, >, <, etc.). A valid expression may include a left hand side term and a right hand side term separated by the operator. In some embodiments, the left hand side term may be a keyword or a commonly used, “human friendly,” word. The right hand side term may be a value of the left hand side term. For example, an expression could be “version=5.0.” In this example, the left hand side term, “version,” may be a recognized keyword (or a commonly used term that may be translated into a recognized keyword by the search computing system 200) and the right hand side term, “5.0,” is a value of the left hand side term, “version.” Similar to the keywords, a list of all recognized operators may be stored within or be accessible by the search computing system 200.

In some other embodiments, the user may enter an Internet Protocol (IP) address as the search query. In yet other embodiments, the user may simply use “human friendly” words to construct the search query, which may then be translated by the query parser 210 into recognized keywords. Thus, the user may enter the search query in the form of keywords, expressions, IP addresses, “human-friendly” terms, or a combination thereof. The search interface 205 may also provide other features in the search box 235. For example, in some embodiments, the search box 235 may have an auto-complete feature, such that as the user is inputting (e.g., typing) the search query, the search interface suggests options to complete the query. The search box 235 may also suggest synonyms, alternate terms, and/or keywords that the user may use as part of the search query. Additional features of the search query are described in the U.S. application Ser. No. 15/143,060 mentioned above.

The search query entered into the search box 235 is sent to the query parser 210 by the search interface 205. The query parser 210 includes a keyword block 250, an expression block 255, an IP address block 260, and a result generator 265. The query parser 210 receives the search query from the search interface 205 and converts that query into a structured query using a tokenizer 270. For example, the tokenizer 270 of the query parser 210 may break or tokenize the search query and particularly, the characters of the search query, into a plurality of tokens. For each token, the tokenizer 270 may identify whether that token corresponds to a recognized keyword. The tokenizer 270 may communicate with the keyword block 250, the expression block 255, and the IP address block 260 to further classify the token and parse the search query. The tokenizer 270 may parse each token and then convert all of the tokens into a structured query that is usable by the search computing system 200.

Although not shown, in some embodiments, the tokenizer 270 may also include or be in communication with additional components such as a ranking block to rank the keywords, a relationship block to identify relationships between the keywords, a matching block to match keywords and assign scores, etc. to facilitate converting the parsed query into a structured query. Additional details of converting the search query into a structured query are provided in the above mentioned U.S. application Ser. No. 15/143,060, again, the entirety of which is incorporated by reference herein.

The keyword block 250 may include a list of all recognized keywords. The expression block 255 may include a list of all recognized expressions, while the IP address block 260 may include a list of all recognized IP addresses. Although shown as separate components, in other embodiments, one or more of the keyword block 250, the expression block 255, and the IP address block 260 may be part of the database 215 or combined with one another. In some embodiments, the database 215 itself may be the same as, or a part of, the storage pool 140. In other embodiments, the database 215 may be separate from the storage pool 140 and may be connected to the storage pool 140 in operational association. Also, in some embodiments, the keyword block 250 and/or the expression block 255 may also include a correlation of “human-friendly” words into recognized keywords.

The structured queries may be stored within the structured query database 220. Although shown as a separate database, in some embodiments, the structured query database 220 may be part of the database 215, the keyword block 250, the expression block 255, and/or the IP address block 260. The structured queries may also be provided to the result generator 265. The result generator 265 may be configured to access the database 215 (as well as other databases within the cluster) to gather information pertaining to the structured queries. The result generator 265 may aggregate and sort the gathered results and display those results within the search display box 240.

The search display box 240 may be divided into various boxes, such as a summary box 275a, an alerts box 275b, a performance metrics box 275c, and other information box 257d. The result generator 265 may sort the search results to be displayed within these various boxes of the search display box 240. Further, the results displayed within each of the summary box 275a, the alerts box 275b, the performance metrics box 275c, and the other information box 275d may or may not be interactive. If interactive, the user may interact with (e.g., click) a particular item within those boxes to view/access additional information related to that item. Some of the boxes may be empty if there are no results to display.

Although the summary box 275a, the alerts box 275b, the performance metrics box 275c, and the other information box 275d are shown herein, in other embodiments, additional, fewer, or different boxes may be displayed. Further, in some embodiments, the number and types of boxes that are displayed within the search display box 240 may vary based upon the content of a search query.

Additionally, the search display box 240 may include a configuration settings box 280 to view or change the settings for how the search results are displayed within the display box, and adjust various settings pertaining to the search interface 205. In some embodiments, the configuration settings box 280 may be provided outside of the search display box 240. The configuration settings box 280 may also be used to configure rules by the user. For example, within the configuration settings box 280, the user may be provided a rule setting option in which the user may specify an “entity type” and a metric to be monitored. For example, the user may specify the “entity type” as “Cluster A” and the metric as a central processing unit (CPU) utilization greater than seventy five percent (CPU utilization>75%). Thus, the user may set a rule to monitor Cluster A for CPU utilization>75%. Once created, the rule may be stored within a rules database, discussed below, of the rules computing system 225. The rules computing system 225 may then automatically monitor the “entity type” (e.g., Cluster A) specified in the rule to identify violations of the rule and issue notifications when violations are detected. For example, every time the rules computing system 225 detects that Cluster A has a CPU utilization>75%, the rules computing system triggers a notification, which may be displayed on the search display box 240. In addition to the rules that are configured by the user, as discussed below, the rules computing system 225 may propose rules to the user, which the user may then authorize the rules computing system to store and implement.

The search display box 240 may further include a rules suggestions box 285 that works collaboratively with the rules computing system 225 to present the proposed rules to the user. Although the rules suggestions box 285 is shown as part of the search display box 240, in some embodiments, the rules suggestions box 285 may additionally or alternatively pop-up as a separate dialog box. In some embodiments, the rules suggestions box 285 may be provided as part of the auto-complete feature of the search box 235 discussed above. In yet other embodiments, the rules suggestions box 285 may be provided as a separate stand-alone feature within the user interface 230. In some embodiments, the rules suggestions box 285 may dynamically suggest rules while the user is inputting the search query. In yet other embodiments, the rules suggestions box 285 may suggest rules, both initially during the inputting of the search query and with the display of the search results. The rules suggestions box 285 may also provide a list of rules that have already been configured for a particular type of query. Further, each of the rules displayed within the rules suggestions box 285, whether suggested or pre-existing, may be an interactive item that the user may interact with (e.g., click on) to view, set, edit, delete, or otherwise alter that rule.

The rules computing system 225 works collaboratively with the structured query database 220 to identify search queries which may be suitable for creating rules. Upon identifying the search queries that are suitable for creating rules, the rules computing system 225 proposes rules to the user in the rules suggestions box 285. The rules computing system 225 may also identify whether rules already exist for certain types of queries. The rules computing system 225 may also execute the created rules periodically to identify any violations of those rules and display the violations in a rule violation box 290. The items displayed within the rule violation box 290 may be interactive that the user may interact with (e.g., click on) to get more information about the violation and to possibly troubleshoot the problem. As used herein, a “rule” that is created and executed by the rules computing system 225 is a constraint or condition that identifies a performance related problem, an alert that has been triggered, or a metric threshold that has been failed. The rules computing system 225 is described in greater detail below.

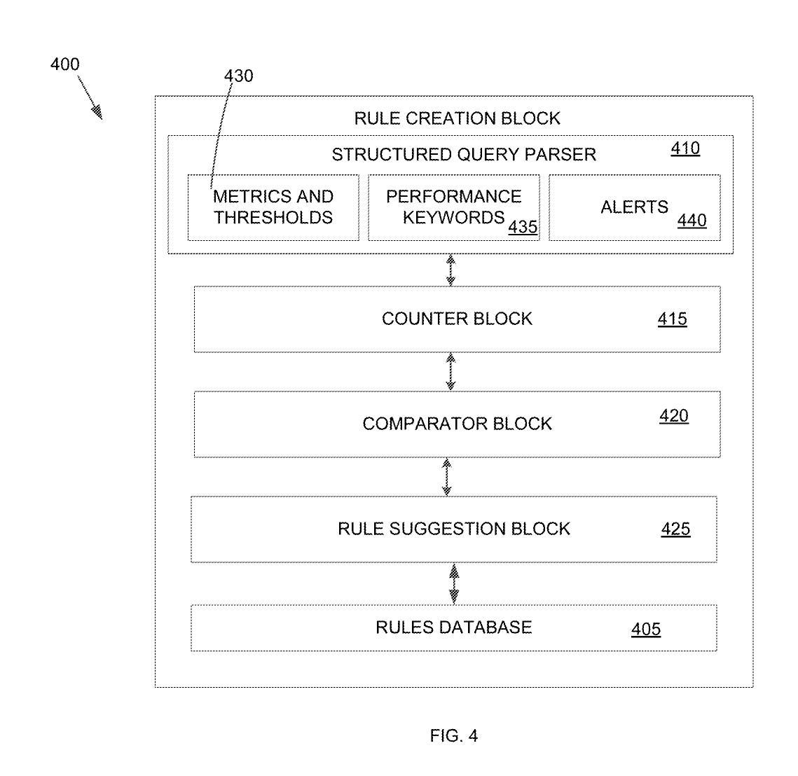

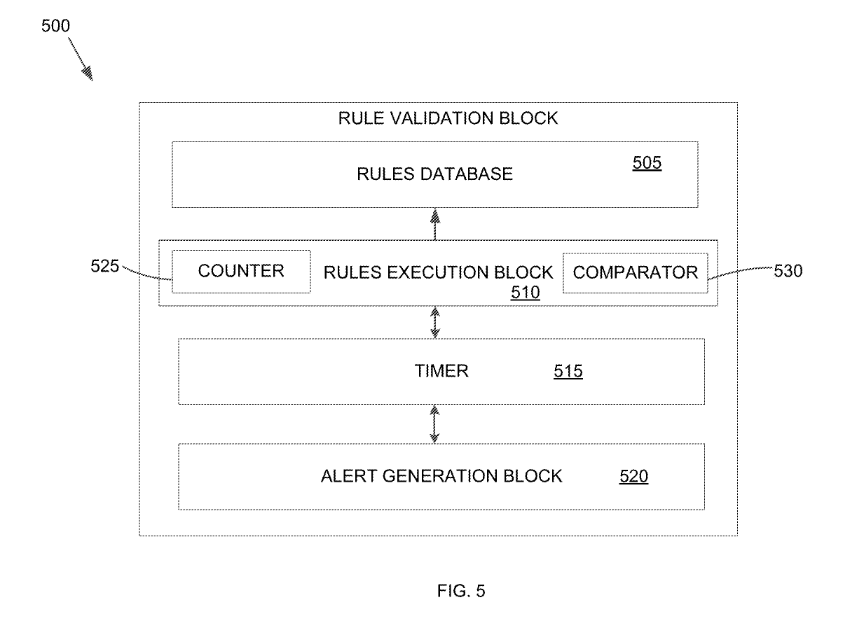

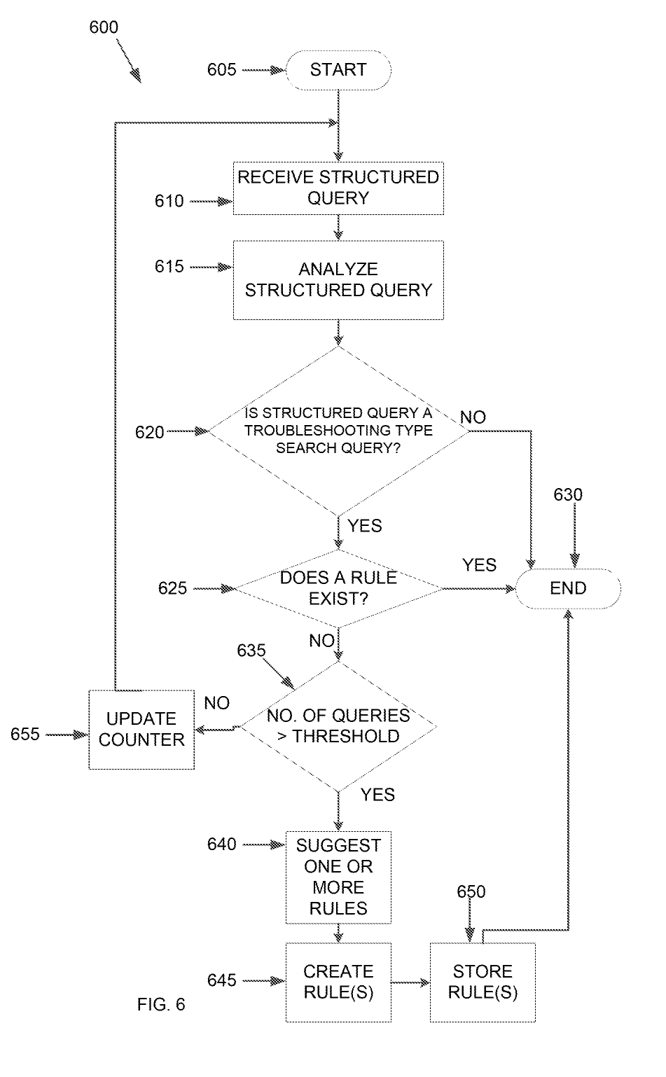

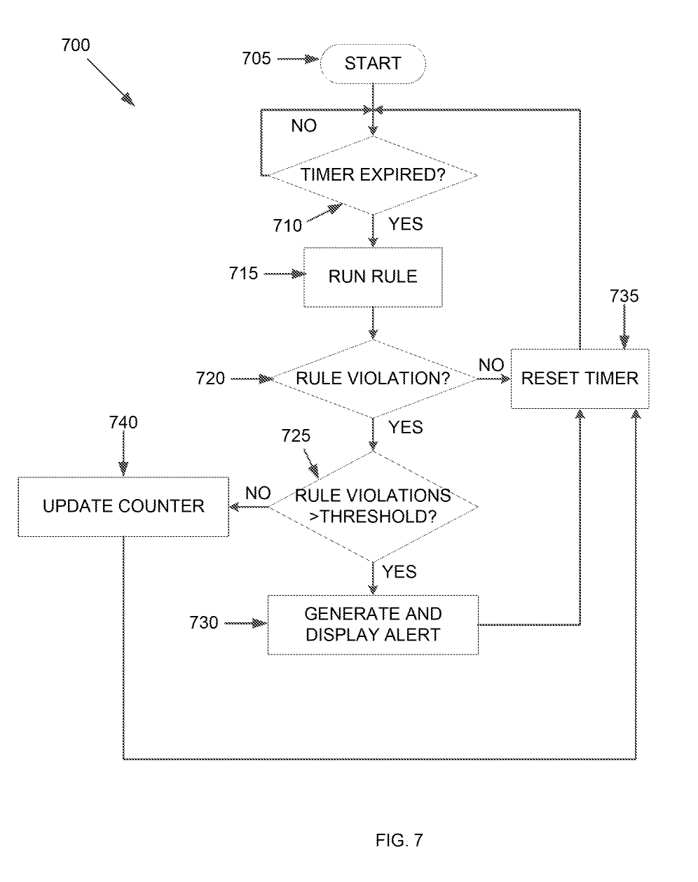

Referring now to FIG. 3, a rules computing system 300 is shown, in accordance with some embodiments of the present disclosure. As indicated above, the rules computing system 300 may be used to propose/create, store, and execute rules based upon search queries. Thus, the rules computing system 300 includes a rule creation block 305 and a rule validation block 310. The rule creation block 305 is configured to identify search queries that may be suitable for creating a rule for, propose rules for those search queries to the user, and store the proposed rules based upon an input (e.g., authorization) from the user. The rule creation block 305 is discussed in greater detail in FIGS. 4 and 6 below. The rule validation block 310 is configured to execute created rules and to identify any violations of the created rules. The rule validation block 310 is also configured to issue alerts to the user when rule violations are detected. The rule validation block 310 is discussed in greater detail in FIGS. 5 and 7 below.

It is to be understood that although the rules computing system 300 has been shown and described herein as a stand-alone component, in some embodiments, the rules computing system may be part of the query parser 210, the structured query database 220, or another component associated with the search computing system 200. In yet other embodiments, the rules computing system 300 may be provided outside of the search computing system 200 and connected to the search computing system in operational association. In some embodiments, the rules computing system 300 need not even be on the same one of the user VMs 120 as the search computing system 200. Rather, since the virtual computing system 100 is a distributed system, the rules computing system 300 may be provided on any one or more of the user VMs 120 (either on the same or different node) that is separate from the user VM having the search computing system 200 and configured to communicate with the search computing system via the controller/service VM 130 and the hypervisor 125. Thus, the rules computing system 300 may be provided on any suitable component within the virtual computing system 100 and configured to communicate with the search computing system 200 for proposing, storing, and validating rules.

Turning now to FIG. 4, an example of a rule creation block 400 is shown, in accordance with some embodiments of the present disclosure. The rule creation block 400 includes a rules database 405 to store created rules, a structured query parser 410 to parse structured queries, a counter block 415 to keep count of a particular type of search query, a comparator block 420 to compare the count from the counter block with a pre-determined threshold, and a rule suggestion block 425 to propose and create new rules.

The rules database 405 is configured to store already created rules. Specifically, the rules database 405 is configured to store user defined rules and system defined rules. User defined rules are those rules that are either created by the user of his/her own volition or the rules that are proposed and created by the rules computing system 300. User defined rules created by the user of his/her own volition are described above with respect to the configuration settings box 280 of FIG. 2. User defined rules created based upon proposals by the rules computing system 300 are discussed below. System defined rules, on the other hand, are those rules that are pre-configured by the manufacturer and stored within the rules database 405. The user may have greater flexibility in viewing, adding, modifying, and/or deleting user defined rules compared to system defined rules.

Furthermore, the rules database 405 may be configured in a variety of ways. For example, in some embodiments, the rules database 405 may be part of the database 215 of FIG. 2. Additionally or alternatively, in some embodiments, the rules database 405 may be part of the storage pool 140 of FIG. 1. In other embodiments, the rules database 405 may even be a stand-alone database separate from the database 215 and/or the storage pool 140. In yet other embodiments, the rules database 405 may be part of the structured query database 220, the rules computing system 225, the rule validation block 310 of the rules computing system 300, or part of another database within the virtual computing system 100. Thus, the rules database 405 may be configured in a variety of ways within the virtual computing system 100 and connected to the rules computing system 300 in operational association.

The structured query parser 410 of the rule creation block 400 may be used to identify search queries that may be suitable for proposing and creating rules for. The structured query parser 410 may be provided as part of the query parser 210 and/or the structured query database 220, discussed above in FIG. 2. Generally speaking, search queries may be categorized into three types of queries (corresponding to the work flow modes discussed above): exploration, management, or troubleshooting. Exploration type search queries are queries where the user is simply browsing or exploring, or looking for information pertaining to those components that are connected to the search computing system 200. Management type search queries are queries that are used to manage or to otherwise perform managerial operations (e.g., add node, delete node, create VM, etc.) on the components connected to the search computing system 200. The managerial operations are not related to or indicative of any faults or malfunctions in the components that are being managed. In contrast, troubleshooting type queries may be indicative of performance problems, faults, or other undesirable conditions within the components connected to the search computing system 200. In some embodiments, the rules are proposed and created by the rules computing system 300 for troubleshooting type search queries.

Thus, the structured query parser 410 is configured to identify troubleshooting type search queries and to distinguish those queries from exploration or management type search queries. Troubleshooting type search queries may be identified based upon certain indicators typically present in the troubleshooting type search queries. For example, a troubleshooting type search query may include keywords, such as slow, fast, high, low, exceeding, greater than, less than, etc., that may be indicative of a performance problem. For example, search queries such as “latency greater than 15 milliseconds” may be indicative of a troubleshooting type search query due to the presence of the metric “latency” and performance keyword “greater than.”

Troubleshooting type search queries may also include expressions for metrics exceeding, falling below, or otherwise not meeting thresholds. For example, a search query in the form of an expression, such as CPU Utilization>75%, may be identified as a troubleshooting query based upon the metric “CPU Utilization.” Additionally, search queries may be identified as troubleshooting queries based upon keywords that suggest an alert. Thus, if the user is looking for alerts (e.g., CPU Utilization Alert, Latency High Alert etc.) occurring within the virtual computing system 100, the rules computing system 300 may classify the search query as a troubleshooting query.

Thus, a search query may be identified as a troubleshooting type search query based upon three indicators: keywords indicative of performance problems based upon a metric, expressions of metrics not meeting thresholds, or keywords of alerts related to metrics. In other embodiments, other indicators may be defined to identify a search query as a troubleshooting type search query. The structured query parser 410 of the rule creation block 400 is configured to parse a structured query and identify whether the structured query represents a troubleshooting type of a search query. In some embodiments, the structured query parser 410 may be connected to the structured query database 220 and/or the query parser 210 to determine when new search queries are available. In some embodiments, the structured query parser 410 may continuously or periodically poll the query parser 210 and/or the structured query database 220 for new structured queries. Alternatively or additionally, the query parser 210 and/or the structured query database 220 may provide all newly created structured queries to the structured query parser 410.

Upon receiving a new structured query, the structured query parser 410 identifies whether the structured query is a troubleshooting type query. In some embodiments, this identification may be performed by the query parser 210 in which case, the structured query parser 410 need not be provided. When provided, the structured query parser 410 may look for the three indicators discussed above within a structured query. Keywords that are indicative of performance problems related to a metric may be pre-programmed within the structured query parser 410. Likewise, keywords that are indicative of an alert based on a metric, and metric thresholds are pre-programmed within the structured query parser 410.

If the structured query parser 410 identifies a structured query as a troubleshooting type search query, then the structured query parser 410 may store the structured query (or a portion of the structured query) or keywords associated with that structured query within one or more of a metrics and thresholds block 430, a performance keywords block 435, and an alerts block 440 based upon the identified keywords in the structured query. Although the metrics and thresholds block 430, the performance keywords block 435, and the alerts block 440 are shown as separate components, in some embodiments, a single component for all of the three indicators (keywords for metrics and thresholds, keywords suggestive of performance problems, and keywords for alerts) may be provided.

Further, in some embodiments, a particular search query may be entered in more than one way. For example, to search for CPU Utilization>75%, the user may use an expression search, as shown above. Alternatively, the user may perform the same or similar search using keywords (e.g., CPU Utilization or CPU Utilization greater than 75%) or alerts (e.g., CPU Utilization Alerts). Since the structured query parser 410 is configured to identify the three indicators discussed above, the structured query parser 410 is able to identify that a given search has been performed before (albeit in a different form).

On the other hand, if the structured query parser 410 determines that a given structured query is not a troubleshooting type of search query, then the structured query parser may simply ignore or discard the structured query and wait for the next query.

Additionally, in some embodiments, the rule creation block 400 may propose a rule to be created after a single occurrence of a troubleshooting type search query. In those embodiments, once the structured query parser 410 identifies a search query as a troubleshooting type search query, the rule creation block 400 may communicate with the rule suggestion block 425 to facilitate proposal of a rule to be created. The rule suggestion block 425 may first communicate with the rules database 405 to determine whether a rule already exists for that troubleshooting type search query. If a rule already does not exist, the rule suggestion block 425 proposes one or more rules for the troubleshooting type search query and presents the proposed one or more rules to the user.

In contrast to proposing one or more rules after every instance of encountering a troubleshooting type search query, in some embodiments, the rule creation block 400 may propose one or more rules to be created after a certain troubleshooting type search query has been entered by the user a pre-determined number of times. To keep track of the number of occurrences of a particular troubleshooting type search query, the counter block 415 may be used. In some embodiments, the counter block 415 may be configured to keep track of each instance of a particular troubleshooting type search query (regardless of the form in which the search query was entered). The count of the particular troubleshooting type search query may be compared with a pre-determined threshold within the comparator block 420. If the count of the counter block 415 exceeds the pre-determined threshold, then the rule suggestion block 425 proposes one or more rules for that particular troubleshooting type search query.

It is to be understood that the counter block 415 is configured to keep a separate count for each different type of a troubleshooting type search query. In other words, each metric may have a separate count. For example, troubleshooting type search queries related to “CPU Utilization” and “latency” may each have a separate count in the counter block 415. In some embodiments, a different pre-determined threshold may be defined for each metric related to the troubleshooting type search queries. For example, troubleshooting type search queries related to “CPU Utilization” may be assigned a first pre-determined threshold, troubleshooting type search queries related to “latency” may be assigned a second pre-determined threshold, and so on.

In yet other embodiments, the rule creation block 400 may track a pattern of the search queries and propose rules to be created based on the pattern. Certain patterns of search queries may be indicative of problems. For example, if the user is searching for CPU Utilization and latency problems within the virtual computing system 100, those search queries may be indicative of a slowness problem within the virtual computing system. In some embodiments, the patterns of the search queries that are indicative of problems may be stored within the virtual computing system (e.g., within a database). The rule creation block 400 may be configured such that if the rule creation block 400 determines that the user has entered certain types of search queries within a pre-determined period of time, the rule creation block may propose a rule.

The rule suggestion block 425 is configured to propose one or more rules for a particular metric or troubleshooting type search query. In some embodiments, a rule may take the format of <entity type keyword><metric keyword><operator><threshold value>. For example, a proposed rule may look like: “Cluster A CPU Utilization>75%.” In other embodiments, the <entity type keyword> in the rule format may be optional. Thus, a rule may look like “CPU Utilization>75%.” Further, for each troubleshooting type search query, the rule suggestion block 425 may possibly propose multiple rules. For example, for CPU Utilization, the rule suggestion block 425 may propose multiple rules of varying scope: “CPU Utilization,” “<Entity Type>CPU Utilization,” “CPU Utilization>75%,” or “<Entity Type>CPU Utilization,” where the entity type may be any of the entity types discussed above.

The rule suggestion block 425 may present the proposed rule(s) to the user via the search interface 205 of FIG. 2. In addition to presenting the proposed rule(s), the rule suggestion block 425 may configure one or more settings for the proposed rule(s). For example, the rule suggestion block 425 may assign a time interval to each proposed rule. The time interval may determine how frequently the rule is to be executed. The time interval may depend upon the criticality of the type of metric that is being monitored by the rule, as well as any other factor that may be deemed desirable or suitable. Upon reviewing the proposed rule(s), the user may select one or more of the proposed rule(s) for implementation, view and/or update the selected ones of the proposed rule(s) and/or the settings configured by the rule suggestion block 425, or ignore the proposed rule(s). The proposed rule(s) selected by the user for creation may be saved by the rule suggestion block 425 within the rules database 405. If none of the proposed rule(s) are selected by the user for creation, the rule suggestion block 425 may either discard those rules or temporarily store the rules for presenting the next time the user runs the troubleshooting type search query for which the rule(s) were proposed.

It is also to be understood that, in some embodiments, rules configured by one user may be invisible to another use within the virtual computing system 100. Thus, the rules may not be configured for sharing. In other embodiments, one or more rules may be designated as global rules that may be visible to and used by multiple users.

Referring now to FIG. 5, an example of a rule validation block 500 is shown, in accordance with some embodiments of the present disclosure. The rule validation block 500 is used to detect violations of already created rules. Thus, the rule validation block 500 may communicate with a rules database 505, which serves as a repository for existing rules. The rules database 505 is the same as the rules database 405. As discussed above with respect to the rules database 405, the rules database 505 may be part of the database 215, the storage pool 140, the structured query database 220, a stand-alone database, part of the rules computing system 300, including being part of the rule creation block 400 and/or part of the rule validation block 500, or provided as part of any other database within the search computing system 200.

The rule validation block 500 may be configured to execute existing rules periodically based upon an expiration of the pre-defined time interval discussed above. Thus, the rule validation block 500 includes a rules execution block 510 and a timer 515. While the timer 515 is shown as being outside of the rules execution block 510, in some embodiments, the timer may be part of the rules execution block as well. In some embodiments, a timer may be provided for every rule within the rules database 505, while in other embodiments, a universal timer may be used for all of the rules. In some embodiments, the user may be able to set a particular pre-determined time interval to separate two executions of a rule, while in other embodiments, the user may be given the option to select a pre-determined time interval from a list of pre-defined time intervals.

Thus, the timer 515 is configured with the pre-determined time interval or threshold, such that upon expiration of that pre-determined time interval, the rule validation block 500 executes the rule(s) corresponding to that pre-determined time interval. For example, if a universal timer is used within the timer 515, then upon the expiration of the pre-determined time interval, the rules execution block 510 executes all of the rules within the rules database 505. In contrast, if each rule is assigned an individual pre-determined time interval within the timer 515, then the rules execution block 510 executes only those rules whose timer has expired (e.g., the pre-determined time interval has run out).

After the execution of the rules upon the expiration of the timer 515, the timer is reset with the pre-determined time interval and the rules execution block 510 waits to execute the rules until the timer has expired again. Thus, the rules execution block 510 periodically executes the rules in the rules database 505. Although the rules execution block 510 has been described as running or executing the rules periodically, in some embodiments, the rules execution block may be configured to continuously execute those rules without waiting for the pre-determined time interval in between two executions of a particular rule.

By executing a rule, the rules execution block 510 identifies any violations of that rule within the virtual computing system 100. For example, if a rule is directed to “CPU Utilization>75%,” the rules execution block 510 may look for all components within the virtual computing system 100 that are connected to the rules computing system 300 in which the CPU utilization is greater than 75%. In contrast, if a rule is directed to “Host CPU Utilization>75%,” the rules execution block 510 will only look for CPU utilization being greater than 75% within the entity type “host.”

Upon finding of a rule violation and, based upon the configuration, the rules execution block 510 may either issue an alert via an alert generation block 520 right away or increase a count within a counter block 525. In some embodiments, the rules execution block 510 may be configured to report every instance of a rule violation. In those cases, when the rules execution block 510 identifies a violation, the rules execution block may communicate with the alert generation block 520 to issue an alert to the user. The alert may be displayed to the user via the rule violation box 290 of FIG. 2 above. In other embodiments, instead of reporting every instance of a rule violation, the rules execution block 510 may be configured to issue an alert after the rule has been violated a pre-determined number of times. Thus, every instance of the rule violation is not reported. However, every instance of the rule violation is recorded using the counter block 525, such that with every instance of a particular rule violation, a count within the counter block is increased.

In some embodiments in which the counter block 525 is used, the number of violations of the rule in each rule execution round may be tracked with the counter block, such that if the number of violations in a single rule execution round exceed the pre-determined threshold, an alert may be issued. In other embodiments, each rule execution round may be deemed a single violation (even if there are multiple violations noted in that round) and the counter block 525 may be used to track the number of rule execution rounds in which the violations have occurred. The count in both cases may be compared with the pre-determined threshold using a comparator block 530. When the count becomes greater than the pre-determined threshold, the rules execution block 510 communicates with the alert generation block 520 to generate and issue an alert to the user.

Thus, when the rule violations are to be reported may be configurable. In some embodiments, each rule may be individually configurable to either report every instance of the rule violation or to report after the number of violations exceed the pre-determined threshold. For example, more critical rules may be configured to report every instance of the violation, while less critical rules may be configured to report after the number of violations exceed the pre-determined threshold. Further, the pre-determined threshold for each rule may vary.

Referring still to FIG. 5, the alert generation block 520 is used to issue alerts of rule violations to the user. The type of alert that is issued for a particular rule violation may be configurable. For example, in some embodiments, the alert generation block 520 may display the alert in the rule violation box 290 of FIG. 2 above. In other embodiments, the alert generation block 520 may, additionally or alternatively, include audible alerts of the rule violation. Other types of audio and visual alerts may also be generated and issued by the alert generation block 520. Further, the format of the alert that is generated and issued by the alert generation block 520 may vary from one embodiment to another. In some embodiments, the alert generation block 520 may gather and display additional information pertaining to the rule violation. For example, the alert may include a list of all components violating that particular rule. The alert may also include identifying and other information of one or more entity types that produced the rule violation, possible causes and/or fixes of the rule violation, other components that may be directly or indirectly impacted by the rule violation, etc.

Therefore, the rule validation block 500 may be used to check for rule violations and to generate and issue alerts for notifying the user of those violations.

Turning now to FIG. 6, a flowchart outlining a process 600 for creating new rules is shown, in accordance with some embodiments of the present disclosure. The process may include additional, fewer, or different operations, depending on the particular embodiment. As discussed above, new rules are created by the rules computing system 225 based upon an analysis of search queries that are entered by the user using the search interface 205. Specifically, new rules are created by the rule creation block 400. Thus, after starting at operation 605, the rules computing system 225 waits to receive a new structured query at operation 610. The structured query is generated by the query parser 210 based upon the search query entered into the search interface 205 by the user. The search query is provided to the query parser 210, which identifies keywords, expressions, and IP addresses within the search query, and generates a structured query from the search query. The structured query is saved within the structured query database 220, as well as provided to the rules computing system 225. In some embodiments, the rules computing system 225 may poll the query parser 210 and/or the structured query database 220 to identify when new structured queries become available.

Upon receiving a new structured query, the rules computing system 225 and particularly, the rule creation block 400 analyzes the structured query at operation 615. Specifically, the structured query parser 410 of the rule creation block 400 may look for three types of metric related keyword indicators within the structured query to determine whether the structured query relates to a troubleshooting type search query. For example, the structured query parser 410 may identify whether the structured query includes any performance related keywords, keywords for metrics and thresholds, or keywords indicative of alerts based on metrics within the structured query. Thus, at operation 620, the structured query parser 410 determines whether the structured query that was received at the operation 610 is a troubleshooting type search query. If the structured query parser 410 finds any of the above mentioned indicators within the structured query, the structured query parser determines that the structured query is indeed a troubleshooting type search query. Then, at operation 625, the rule creation block 400 communicates with the rules database 405 to determine whether a rule already exists for that particular troubleshooting type search query.

On the other hand, if at the operation 620, the structured query parser 410 determines that the structured query received at the operation 610 is not a troubleshooting type search query (e.g., because the structured query parser did not find performance related keywords, keywords for metrics and thresholds, or keywords indicative of alerts for metrics in the structured query), then the process 600 goes to operation 630 and the rule creation block 400 waits for the next structured query.

At the operation 625, the rule creation block 400 determines whether a rule already exists for the troubleshooting type search query identified at the operation 620. In some embodiments, the rule creation block 400 may search the rules database 405 to look for rules having the same keyword indicators (e.g., the performance related keywords, keywords for metrics and thresholds, or keywords indicative of alerts based on metrics) that the structured query parser 410 identified in the structured query at the operations 615 and 620 to identify whether a rule already exists. In other embodiments, other methods may be used to identify whether a rule already exists for a particular troubleshooting type search query. If a rule already exists, then the process 600 ends at the operation 630.

On the other hand, if at the operation 625, no existing rule is found, then at operation 635, the rule creation block 400 and, particularly the counter block 415 and the comparator block 420 determine whether the structured query relates to a commonly performed search query. Specifically, every time the rule creation block 400 encounters a particular troubleshooting type search query for which a rule does not exist, the rule creation block increases a count within the counter block 415 and compares the count with a pre-determined threshold within the comparator block 420. When the count exceeds the pre-determined threshold, the rule creation block 400 suggests one or more rules to be created for that troubleshooting type search query.

By virtue of using the counter block 415 and the comparator block 420, the rule creation block 400 is able to identify the troubleshooting type search queries that are most commonly used and suggest rules for only those search queries. In some embodiments, the rule creation block 400 may be configured to suggest a rule for each troubleshooting type search query and for which a rule does not exist. In those embodiments, the counter block 415 and the comparator block 420 may not be needed and the operation 635 may be skipped.

In yet other embodiments, in addition to or instead of identifying commonly used troubleshooting type search queries, the rule creation block 400 may identify patterns of troubleshooting type search queries that may be indicative of a problem. Specifically, upon detecting specific types of troubleshooting search queries within a pre-determined period of time, the rule creation block 400 may determine that the sequence of the search queries matches a predefined pattern, which may be indicative of a problem. When the rule creation block 400 detects such patterns, it may suggest one or more rules.

At the operation 635, if a counter is used and the count exceeds the pre-determined threshold, the process 600 goes to operation 640 where the rule creation block 400 suggests one or more rules. As discussed above, the rule suggestion block 425 may be used to propose one or more rules for the particular troubleshooting type search query and configure settings for those rule(s). The rule suggestion block 425 may then present the proposed and configured rule(s) to the user, as discussed above. The user may decide to accept one or more of the rules as proposed and configured by the rule suggestion block 425, modify the rule(s), or decline the rule(s). If the rule suggestion block 425 receives an indication back from the user to create one or more of the rules, either as proposed and configured by the rule suggestion block or with modifications incorporated by the user, the rule suggestion block creates the rule at operation 645.

The rule suggestion block 425 may also save that rule within the rules database 405 at operation 650 before the process 600 ends at the operation 630. If, at the operation 635, the count does not exceed the pre-determined threshold, the counter associated with that structured query is updated at operation 655 and the process 600 returns to the operation 610 to wait for the next structured query.

Referring now to FIG. 7, a flowchart of a process 700 outlining operations to be performed in executing the created rules is shown, in accordance with at least some embodiments of the present disclosure. The process may include additional, fewer, or different operations, depending on the particular embodiment. As discussed above, the rule validation block 500 may be used to execute rules periodically that are stored within the rules database 505. Specifically, to execute a particular rule from the rules database 505, after starting at operation 705, the rules execution block 510 determines whether the timer 515 associated with that particular rule has lapsed at an operation 710. Specifically, the timer 515 is run for a pre-determined time interval, and when the timer runs out of the pre-determined time interval, the rules execution block 510 executes the rule. Thus, if at the operation 710, the rules execution block 510 determines that the timer 515 has run out for the particular rule being executed, the rules execution block runs the rule at operation 715. If the timer 515 has not run out at the operation 710, the process 700 stays at the operation 710 until the timer has run out.

Thus, the operation 715 is reached after the timer 515 at the operation 710 has timed out. After running the rule at the operation 715, the rules execution block 510 identifies whether any violations of that rule were detected at operation 720. If violations were detected, then the rules execution block 510 determines whether the number of violations of that particular rule have exceeded a pre-determined threshold at operation 725. Specifically, the rules execution block 510 looks at the violation count of that particular rule within the counter block 525 and compares that violation count using the comparator block 530. If the comparator block 530 determines that the pre-determined threshold has been exceeded at the operation 725, an alert is generated and displayed at operation 730 by the alert generation block 520 and the timer 515 is reset at operation 735. In some embodiments, the operation 735 may be performed before or simultaneously with the operation 730.

If, on the other hand, at the operation 725, the pre-determined threshold is not exceeded, then at operation 740, the rules execution block 510 increments the count of the counter associated with that particular rule and resets the timer 515 at the operation 735. Once the timer 515 is reset at the operation 735, the process 700 returns to the operation 710 to wait for the timer to run out and execute the rule again. The process 700 may be performed for every rule within the rules database 505.

Thus, the present disclosure provides a system and method for automatically analyzing search queries and automatically proposing rules to the user for certain types of search queries. Once the rules are created, the present disclosure also provides a system and method to execute those rules to monitor for certain undesirable conditions within the virtual computing system 100. By virtue of analyzing search queries, proposing, creating, and running rules, the present disclosure timely detects problems monitored by those rules within the virtual computing system 100, possibly suggests causes, and fixes for those problems. Thus, the present disclosure aids the user in troubleshooting and by timely identifying certain problems, may prevent those problems from escalating or adversely impacting other components of the virtual computing system 100.

Although the present disclosure has been described in the context of creating and executing rules for troubleshooting type search queries, in other embodiments, similar rules may be created for other types of search queries as well.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
creating, by a rules computing system of a virtual computing system, a rule based upon one or more search queries entered into a search interface of the virtual computing system;
executing, by the rules computing system, the rule periodically for identifying violations of the rule; and
issuing, by the rules computing system, an alert for the violations of the rule on the search interface.

2. The method of claim 1, further comprising:
proposing, by the rules computing system, the rule on the search interface before creating; and
creating, by the rules computing system, the rule based upon the rule that is proposed and a user input.

3. The method of claim 1, further comprising identifying, by the rules computing system, troubleshooting type search queries from the one or more search queries.

4. The method of claim 1, further comprising:
converting, by the rules computing system, each of the one or more search queries into a structured query;
identifying, by the rules computing system, keywords within the structured query indicative of a troubleshooting type search query; and
creating, by the rules computing system, the rule if the structured query is indicative of the troubleshooting type search query.

5. The method of claim 4, further comprising:
checking, by the rules computing system, a rules database to determine if an instance of the rule already exists; and
creating, by the rules computing system, the rule if the rule is not found in the rules database.

6. The method of claim 4, further comprising:
incrementing, by the rules computing system, a count of a counter for each instance of the troubleshooting type search query identified by the rules computing system;
comparing, by the rules computing system, the count with a pre-determined threshold; and
creating, by the rules computing system, the rule upon the count exceeding the pre-determined threshold.

7. The method of claim 1, further comprising storing, by the rules computing system, the rule in a rules database associated with the rules computing system.

8. The method of claim 1, further comprising executing the rule upon expiration of a pre-determined time interval.

9. The method of claim 1, further comprising:
incrementing, by the rules computing system, a count of a counter for each instance of the violations of the rule;
comparing, by the rules computing system, the count with a pre-determined threshold; and
issuing, by the rules computing system, the alert upon the count exceeding the pre-determined threshold.

10. A system, comprising:
a rules computing system having:
a rules database configured to store one or more rules created by the rules computing system; and
a processing unit configured to:
create the one or more rules based upon one or more search queries entered into a search interface, wherein the rules computing system and the search interface are part of a virtual computing system;
store the created ones of the one or more rules in the rules database;
execute the created ones of the one or more rules periodically to detect violations of the created ones of the one or more rules; and
generate alerts to be issued on the search interface based upon detected violations.

11. The system of claim 10, wherein the rules computing system is provided on a user virtual machine within the virtual computing system.

12. The system of claim 11, wherein the user virtual machine is created on a host machine that is connected to other host machines within the virtual computing system via a network to form one or more clusters.

13. The system of claim 12, wherein the rules computing system is configured to detect violations of the created ones of the one or more rules within at least one of the one or more clusters.

14. A method comprising:
identifying, by a rules computing system, keywords in one or more search queries entered into a search interface for identifying a troubleshooting type search query, wherein the rules computing system and the search interface are part of a virtual computing system;
proposing, by the rules computing system, one or more rules for each troubleshooting type search query;
storing, by the rules computing system, at least one proposed rule in a rules database based upon a user input;
executing, by the rules computing system, the at least one proposed rule from the rules database periodically for identifying violations of the at least one proposed rule; and
issuing, by the rules computing system, an alert for the violations, wherein the alert is provided on the search interface.

15. The method of claim 14, further comprising identifying at least one metric keyword in the one or more search queries for identifying the troubleshooting type search query.

16. The method of claim 14, further comprising identifying at least one alert keyword based on a metric in the one or more search queries for identifying the troubleshooting type search query.

17. The method of claim 14, further comprising converting each of the one or more search queries into a structured query before identifying the keywords.

18. The method of claim 14, further comprising:
incrementing, by the rules computing system, a count of a counter for each instance of the troubleshooting type search query identified by the rules computing system;
comparing, by the rules computing system, the count with a pre-determined threshold; and
proposing, by the rules computing system, the one or more rules upon the count exceeding the pre-determined threshold.

19. The method of claim 14, further comprising:
incrementing, by the rules computing system, a count of a counter for each instance of the violations of the at least one proposed rule;
comparing, by the rules computing system, the count with a pre-determined threshold; and
issuing, by the rules computing system, the alert upon the count exceeding the pre-determined threshold.

20. The method of claim 14, wherein the proposing and the executing occur automatically without the user input.
